(19) United States
(12) Patent Application Publication
(10) Pub. No.: US 2018/0015381 A1
(43) Pub. Date: Jan. 18, 2018

(54) LAWN ORNAMENT HAVING FLUID AND/OR WIND DRIVEN SPINNING ELEMENTS WITH MULTI-AXES ROTATION

(71) Applicant: Plow & Hearth, LLC, Madison, VA (US)

(72) Inventors: Paul D. MAGUIRE, Goochland, VA (US); Frank Qiu, Richmond, VA (US)

(21) Appl. No.: 15/625,335

(22) Filed: Jun. 16, 2017

Related U.S. Application Data
(63) Continuation-in-part of application No. 15/208,883, filed on Jul. 13, 2016.

(51) Int. Cl. A63H 29/14; B05B 3/04; B05B 1/14

(52) U.S. Cl. CPC A63H 29/14; B05B 1/14; B05B 3/0463

(57) ABSTRACT

A lawn or garden ornament that utilizes either wind power or a flow of fluid to rotate various structural or spinning elements about multiple axes of rotation. When wind power is used, the spinning elements may rotate in unison about a vertical axis. When a fluid power is used, the spinning elements will additionally rotate independently of each other about a horizontal axis, and will turn in unison about the vertical axis. When fluid power is used, the fluid may additionally be used for watering of a garden as the design of the decorative lawn ornament promotes an even distribution of fluid to the surrounding support surface.

### CROSS-REFERENCE TO RELATED APPLICATIONS

This application is a continuation-in-part of U.S. patent application Ser. No. 15/208,883 (filed Jul. 13, 2016), which is hereby incorporated by reference in its entirety.

### TECHNICAL FIELD

Embodiments relate to a lawn and/or garden ornament that utilizes either wind power or a flow of fluid to rotate various structural or spinning elements about multiple axes of rotation. When wind power is used, the spinning elements may rotate in unison about a vertical axis. When a fluid power is used, the spinning elements will additionally rotate independently of each other about a horizontal axis, and will turn in unison about the vertical axis. When fluid power is used, the fluid may additionally be used for watering of a garden as the design of the decorative lawn ornament promotes an even distribution of fluid to the surrounding support surface.

### BACKGROUND

Lawn and/or garden ornaments are generally placed in an open lawn and/or garden area of a property.

### DRAWINGS

FIG. 1 illustrates a decorative lawn ornament, in accordance with embodiments.

FIG. 2 illustrates a side partial view of the inner frame and outer frame of the decorative lawn ornament of FIG. 1.

FIG. 3 illustrates a partial perspective view of the inner frame and outer frame of the decorative lawn element of FIG. 1.

FIG. 4 illustrates a partial bottom view of the inner frame and outer frame of the decorative lawn element of FIG. 1.

FIG. 5 illustrates a view of the support member of the decorative lawn element of FIG. 1.

FIG. 6 illustrates a top view of the inner frame and outer frame of the decorative lawn element of FIG. 1.

FIG. 7 illustrates a partial view of discharge of fluid from the inner frame and outer frame of the decorative lawn element of FIG. 1.

FIG. 8 illustrates a side view of the fluid spray pattern of the inner frame and outer frame of the decorative lawn element of FIG. 1.

FIG. 9 illustrates the fluid spray zones from the decorative lawn element of FIG. 1.

FIG. 10 illustrates a side partial view of an inner frame and an outer frame of a decorative lawn ornament, in accordance with embodiments.

FIG. 11 illustrates a decorative lawn ornament having multiple spinning elements configured for two-axis rotation, in accordance with embodiments.

FIG. 12 illustrates a partial side view of the decorative lawn ornament of FIG. 11.

FIG. 13 illustrates a partial view of the support member of the decorative lawn ornament of FIG. 11.

FIG. 14 illustrates a partial perspective view of the frame and the spinning elements of the decorative lawn element of FIG. 11.

FIG. 15 illustrates a partial perspective view of the decorative lawn element of FIG. 11, with one spinning element being removed.

FIG. 16 illustrates a partial perspective view of the decorative lawn element of FIG. 11, with both spinning elements being removed.

FIG. 17 illustrates a partial perspective view of the direction of fluid spray of the decorative lawn element of FIG. 11, with one spinning element being removed.

FIG. 18 illustrates a side view of the connection between the frame and the spinning elements of the decorative lawn element of FIG. 11.

FIG. 19 illustrates a side view of the decorative lawn element of FIG. 18, and the direction of fluid spray from the frame.

FIG. 20 illustrates the fluid spray zones from the decorative lawn element of FIG. 11.

FIG. 21 illustrates the fluid spray zones from the decorative lawn element of FIG. 11.

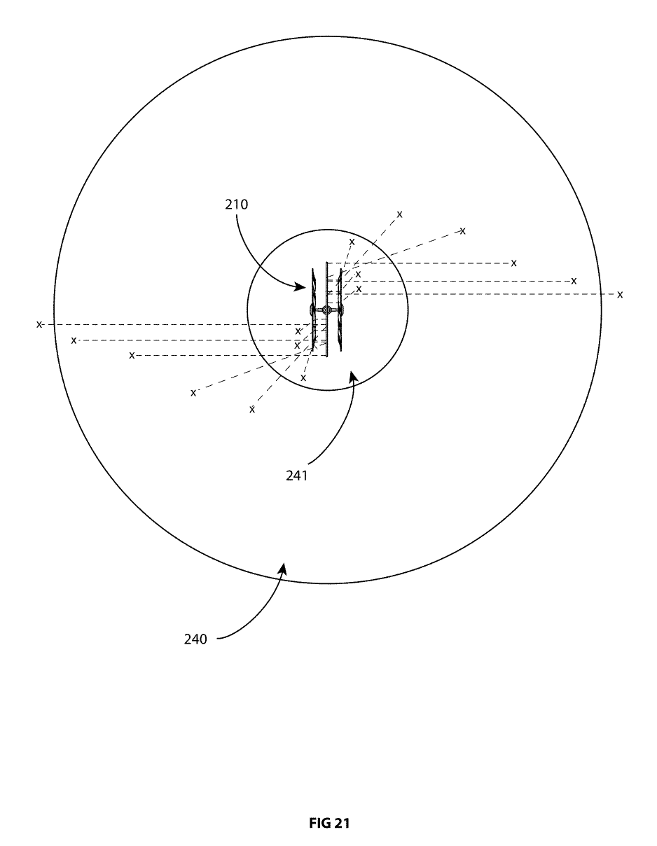

FIG. 22 illustrates a decorative lawn ornament having a single spinning element, in accordance with embodiments.

### DESCRIPTION

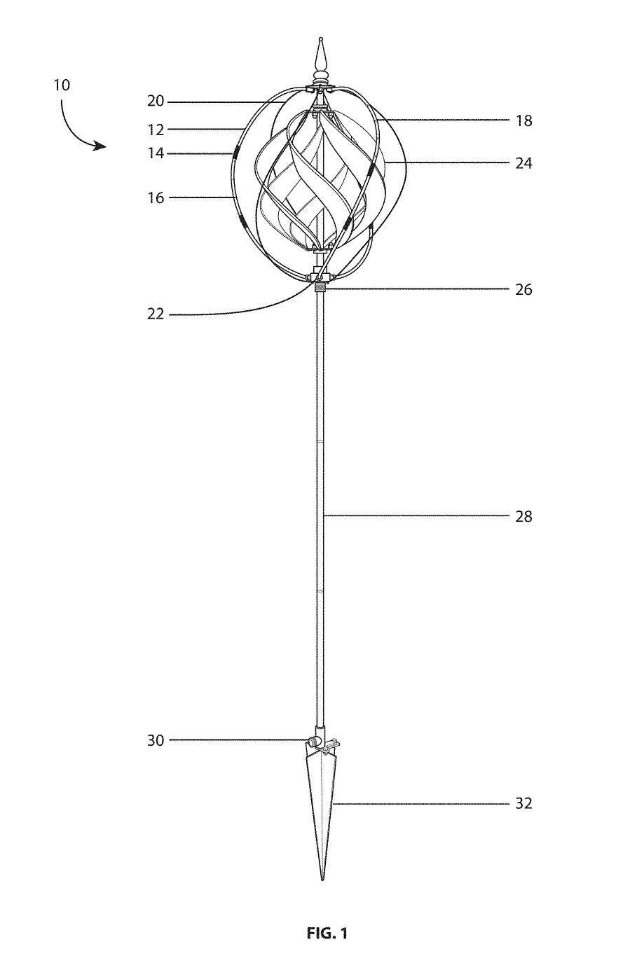

As illustrated in FIG. 1, in accordance with embodiments is a decorative lawn ornament 10 for placement in an open area of a lawn, garden or the like for supplying a fluid such as water to an underlying support surface. The lawn ornament 10 includes an outer frame 12, 20 comprising fluid conduits 12 and support rods 20, an inner frame 24, and a support member 28 which supports the outer frame 12, 20 and the inner frame 24. In accordance with embodiments, at least one of the frames 12, 20, 24 may have an ornamental or decorative appearance.

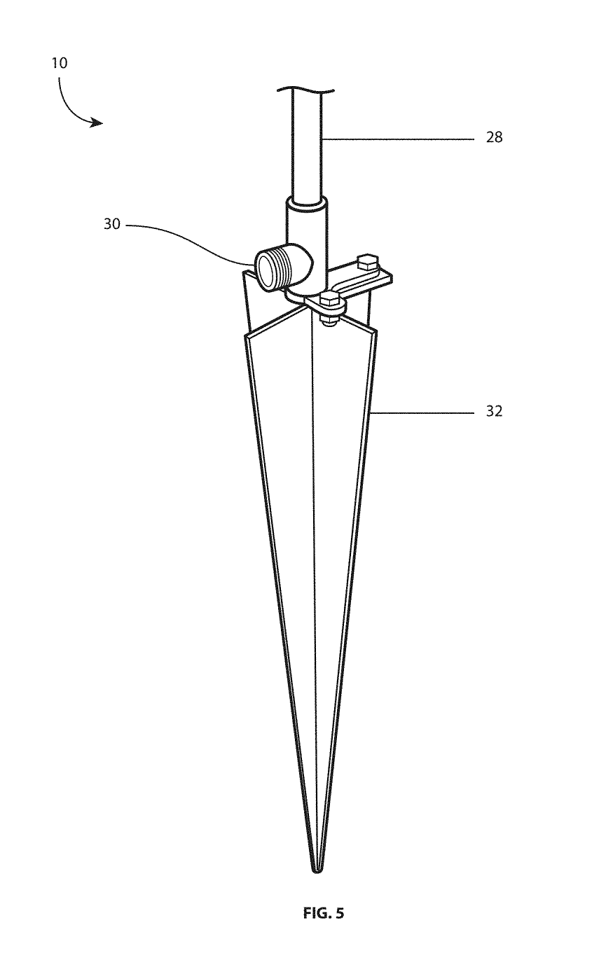

The support member 28, at a proximal end thereof, is to support the outer frame 12, 20 and the inner frame 24. As illustrated in FIG. 5, the support member 28, at a distal end thereof, has a base or anchor such as, for example, a ground spike 32 that is insertable into a support surface which is to support the lawn ornament 10. Embodiments are not limited to a spike 32, and thus, may encompass other anchoring devices such as, for example, other types of anchoring devices, such as a weighted base, anchor, four-point spike, and any other device that permits practice of the embodiments. The support surface may be a natural one that includes the ground of the lawn, garden or the like, or an artificial one that is to be placed on and/or over the lawn, garden or the like. The support member 28 includes a fluid connector 30 to permit fluidic communication of the lawn ornament 10 with a fluid source, such as a water supply system.

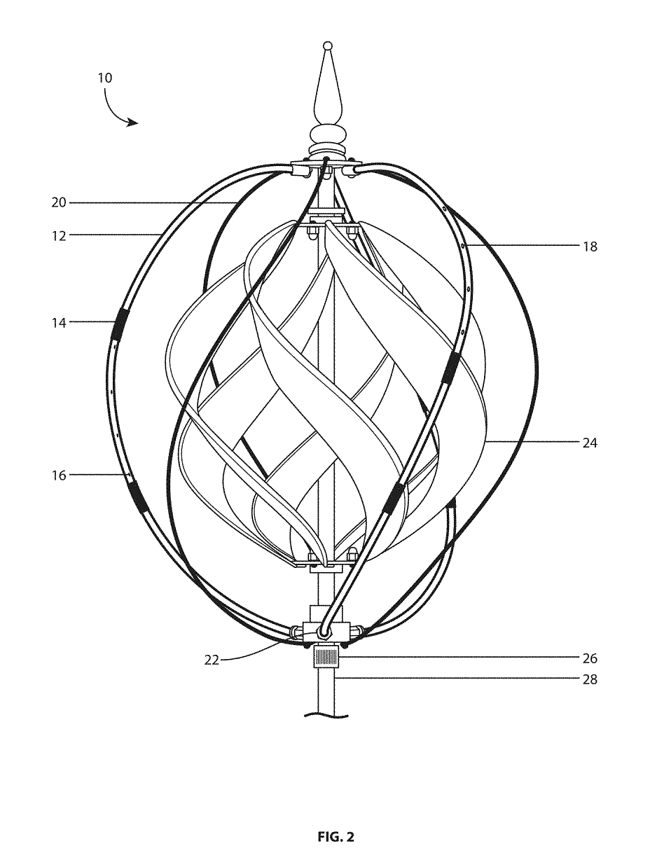

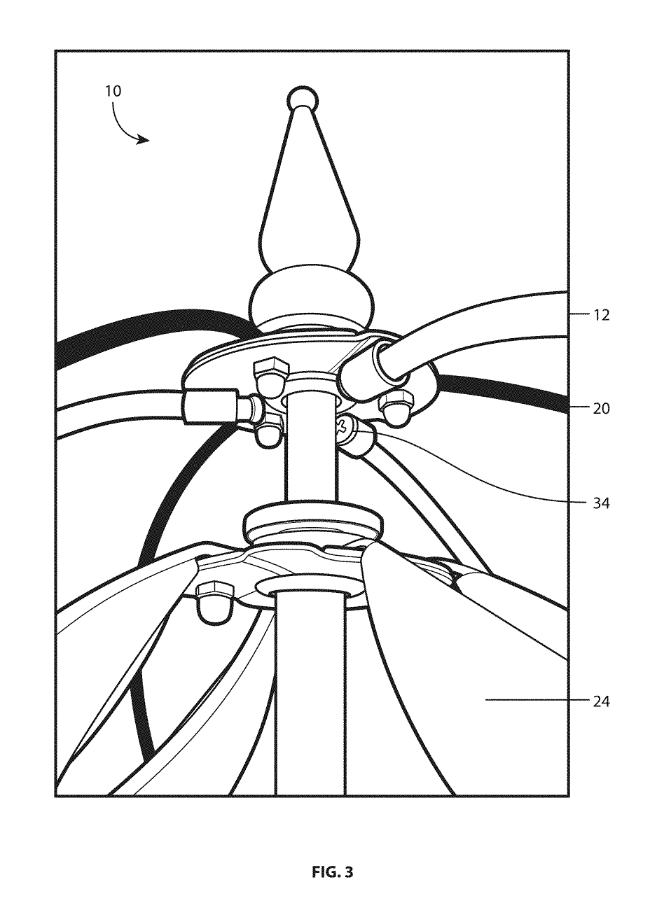

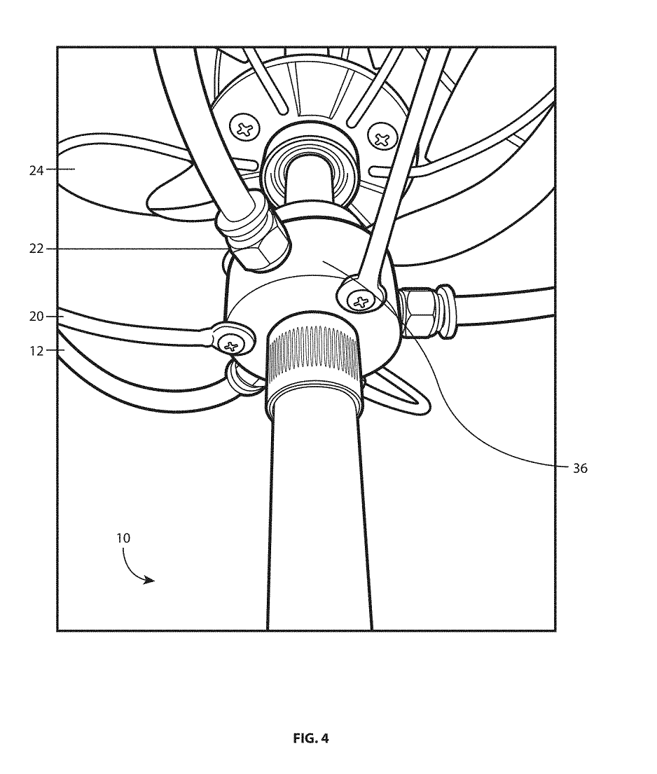

As illustrated in FIGS. 2-4 and 6, the inner frame 24 is to be supported on the support member 28 for rotational movement about a longitudinal axis defined by the support member 28. The inner frame 24 may include at least one inner frame member or blade mechanically connected at upper and/or lower connected regions thereof to a corresponding bearing or collar that is to be arranged on the support member 28. While the inner frame 24 is illustrated having a twisting shape, embodiments are not limited to such a configuration. The inner frame 24 may have any shape that permits practice of embodiments.

In accordance with embodiments, in operation of the lawn ornament 10, the inner frame 24 may be supported on the support member 28 so as to be driven for rotation by wind power. Meaning, rotation of the inner frame 24 may be initiated when a flow of air strikes a surface of the blades.

The outer frame 12, 20 is to be supported on the support member 28, and is concentrically, or orbitally arranged with respect to the inner frame 24. Alternatively, the outer frame 12, 20 may be supported non-concentrically, or non-orbitally with respect to the inner frame 24. The outer frame 12 may comprise at least one outer frame member 12 formed as fluid sprinkler conduits to receive and permit flow of a fluid, and at least one outer support rod 20 that have a structural support function. The outer frame 12, 20 is sealingly connected to the support member 28, at an upper region thereof, via upper connection points 34, and/or at a lower region thereof, via fluid connections 22, to central rotating member 36. A stem that supports the outer frame 12, 20 and the inner frame 24 is connected at lower connection collar 26.

In accordance with embodiments, the outer frame 12, 20 may be connected to the support member 28 for rotational movement about a longitudinal axis defined by the support member 28. While the outer frame members 12 and the outer frame support rods 20 are illustrated having a generally circular configuration, embodiments are not limited thereto. The outer frame members 12 and the outer frame support rods 20 may have any shape that permits practice of embodiments.

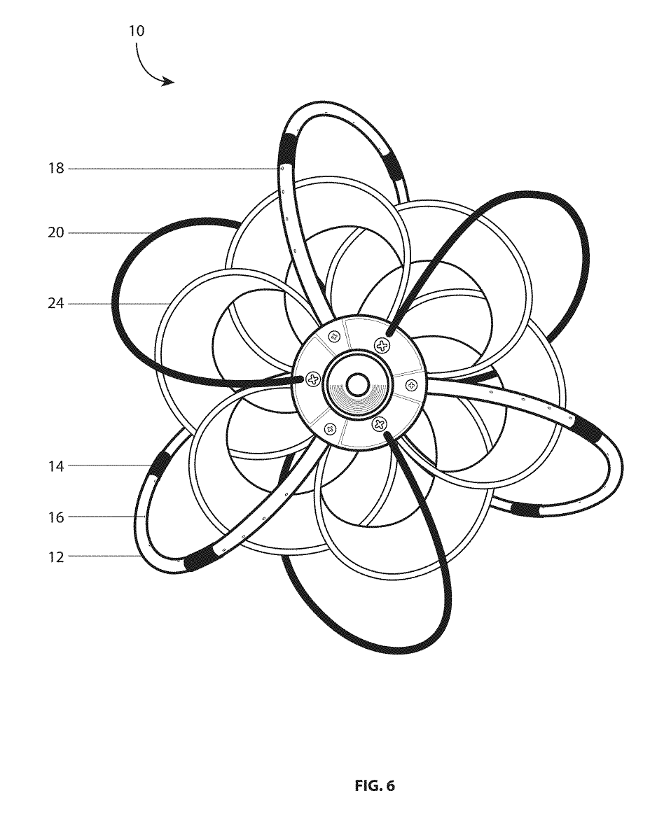

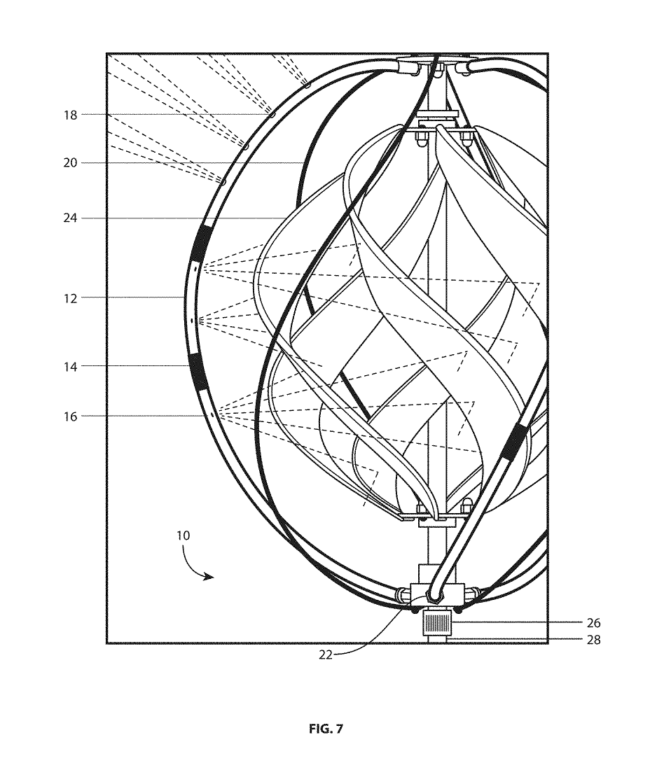

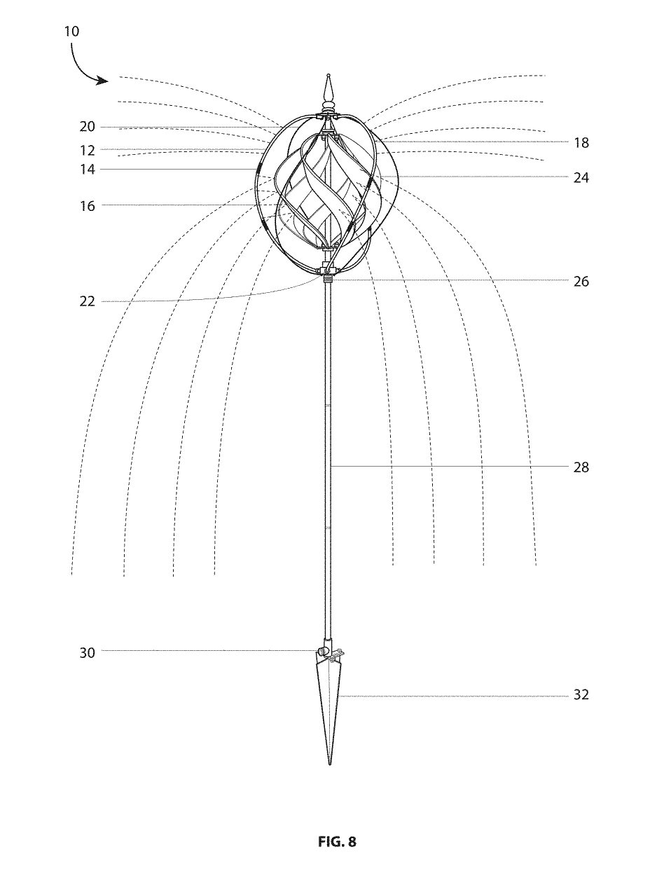

As illustrated in FIGS. 6-9, the outer frame fluid conduits 12 are in fluidic communication with the support member 28 to receive fluid from the fluid source that flows through the support member 28. At least one outer frame fluid conduit 12 includes at least one first aperture, nozzle, hole, or orifice 18. Multiple first orifices 18 are to be spaced apart from each other. The at least one first orifice 18 is configured to discharge or otherwise direct a portion of the fluid in a first direction outwardly from the outer frame fluid conduit 12 to impart, induce, or cause rotation of the outer frame fluid conduit 12 relative to the inner frame 24 and the support member 28.

At least one outer frame fluid conduit 12 includes at least one second aperture, nozzle, hole, or orifice 16. Multiple second orifices 16 are to be spaced apart from each other. The at least one second orifice 16 is configured to discharge or otherwise direct a portion of the fluid in a second direction inwardly from the outer frame fluid conduit 12. The inwardly directed fluid is to contact or otherwise strike a surface of the inner frame 24, and thereby impart, induce, or otherwise cause rotation of the inner frame 24 relative to the outer frame 12, 20 and the support member 28. In that way, the inner frame may be driven not only by force of wind, but also by force of the contacting fluid discharged from the at least one orifice 16.

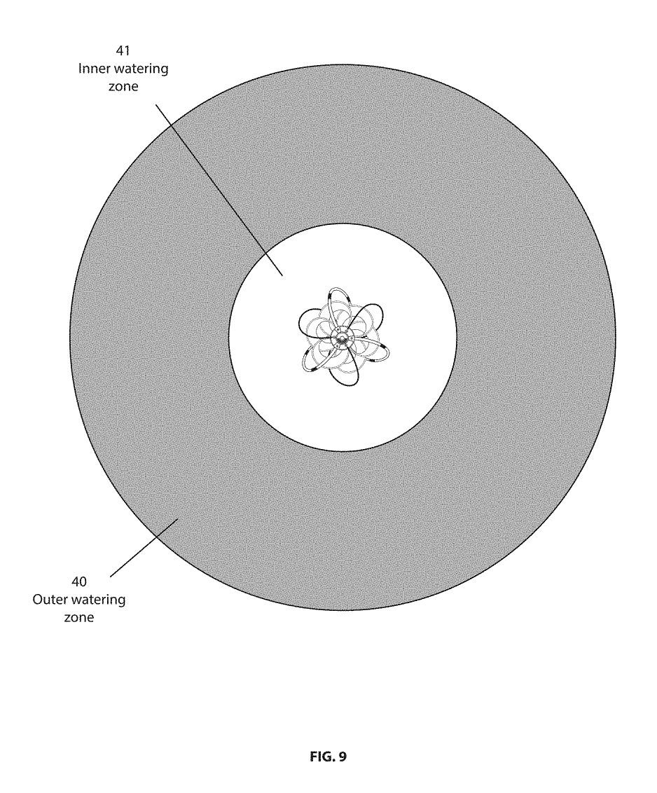

As illustrated in FIG. 9, the at least one first aperture, nozzle, hole, or orifice 18, due to being arranged outwardly on the surface of the outer frame 12, 20 is to direct the fluid to an area on a support surface that creates a first fluid spray zone 40. The at least one second aperture, nozzle, hole, or orifice 16, due to being arranged inwardly on the surface of the outer frame 12, is to direct the fluid, upon contact with the inner frame 24, to an area on a support surface that creates a second fluid spray zone 41 that is arranged concentric to the first fluid spray zone 40. Alternatively, the fluid spray zones 40, 41 may be non-concentrically arranged with respect to each other.

In accordance with embodiments, in operation of the lawn ornament 10, the outer frame 12, 20 may be supported on the support member 28 so as to be driven for rotation by discharge of the fluid therefrom. Alternatively, or additionally, the outer frame 12, 20 may be supported on the support member 28 so as to be driven for rotation due to a flow of air striking a surface thereof.

In accordance with embodiments, while the first fluid spray zone 40 is illustrated as being greater in area than the second fluid spray zone 41, embodiments are not limited thereto. The first fluid spray zone 40 and the second fluid spray zone 41 may be unequal in area such that the first fluid spray zone 40 is lesser in area than the second fluid spray zone 41.

In accordance with embodiments, while the first fluid spray zone 40 and the second fluid spray zone 41 are circular, embodiments are not limited thereto. The first fluid spray zone 40 and the second fluid spray zone 41 may have a non-circular geometric shape that permits practice of embodiments.

At least one outer frame fluid conduit 12 may include at least one cover sleeve 14 arranged for selective movement along the length of a corresponding outer frame fluid conduit 12. Such selective movement is to block discharge of the fluid from one or more orifices 16, 18, thereby controlling discharge of the fluid from the outer frame fluid conduit 12. This arrangement is advantageous in permitting a user to selectively modify or customize the spray radius, volume, and/or area that create the fluid spray zones 40, 41. For instance, a user may prefer that a certain area receive more or less fluid. The at least one cover sleeve 14 may be removeably attached to a corresponding outer frame fluid conduit 12, or alternatively, permanently attached.

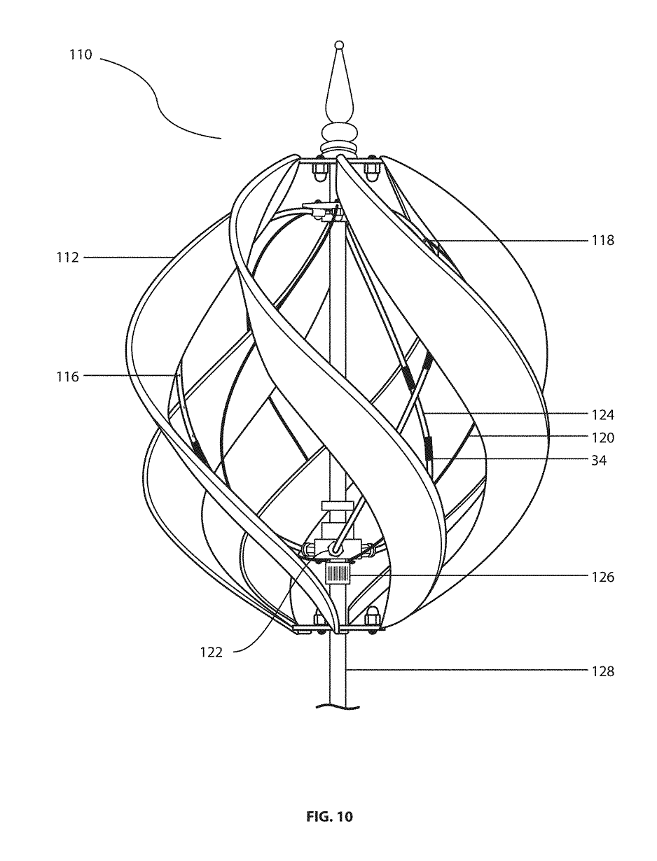

As illustrated in FIG. 10, in accordance with embodiments, alternatively, the decorative lawn ornament 110 may be configured such that the outer frame 112 is to be driven for rotation by air, and the inner frame 124, 120 is to be driven for rotation by discharge of the fluid therefrom. In this embodiment, the inner frame 124, 120 is to cause further rotation of the outer frame 112 due to outwardly directed fluid contacting or otherwise striking a surface of the outer frame 112, and thereby imparting, inducing, or otherwise causing rotation of the outer frame 112 relative to the inner frame 124, 120 and the support member 128.

The inner frame 124, 120 is to be supported on the support member 128, and is concentrically, or orbitally arranged with respect to the outer frame 112. Alternatively, the inner frame 124, 120 may be supported non-concentrically, or non-orbitally with respect to the outer frame 112. The inner frame 124 may comprise at least one inner frame member 124 formed as a fluid sprinkler conduit to receive and permit flow of a fluid, and at least one inner support rod 120 that has a structural support function. The inner frame 124, 120 is sealingly connected to the support member 128, at an upper region thereof, via upper connection points, and/or at a lower region thereof, via fluid connections 122, to a connection collar. A stem that supports the inner frame 124, 120 and the outer frame 112 is connected at lower connection collar 126.

In accordance with embodiments, the inner frame 124, 120 may be connected to the support member 128 for rotational movement about a longitudinal axis defined by the support member 128. While the inner frame members 124 and the inner frame support rods 120 are illustrated having a generally circular configuration, embodiments are not limited thereto. The inner frame members 124 and the inner frame support rods 120 may have any shape that permits practice of embodiments.

As illustrated in FIG. 10, the inner frame fluid conduits 124 are in fluidic communication with the support member 128 to receive fluid from the fluid source that flows through the support member 128. At least one inner frame fluid conduit 124 includes at least one first aperture, nozzle, hole, or orifice 118. Multiple first orifices 118 are to be spaced apart from each other. The at least one first orifice 118 is configured to discharge or otherwise direct a portion of the fluid in a first direction outwardly from the inner frame fluid conduit 124. The outwardly directed fluid is to contact or otherwise strike a surface of the outer frame 112, and thereby impart, induce, or otherwise cause rotation of the outer frame 112 relative to the inner frame 124, 120 and the support member 128. In that way, the outer frame may be driven not only by force of wind, but also by force of the contacting fluid discharged from the at least one orifice 118.

The at least one inner frame fluid conduit 124 may also include at least one second aperture, nozzle, hole, or orifice 116. Multiple second orifices 116 are to be spaced apart from each other. The at least one second orifice 116 is configured to discharge or otherwise direct a portion of the fluid in a second direction from the inner frame fluid conduit 124 to direct the fluid to an area on a support surface that creates a spray zone.

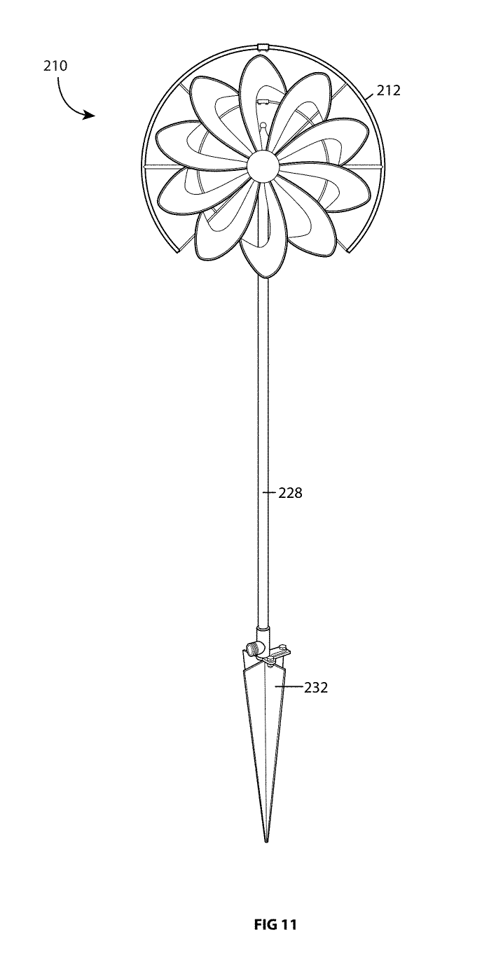

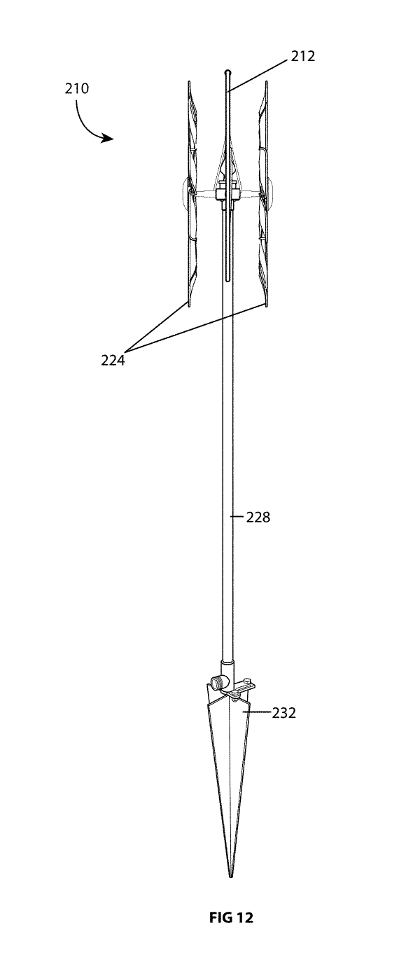

As illustrated in FIGS. 11 and 12, in accordance with an embodiment, a decorative lawn ornament 210 comprises a head assembly that includes at least one frame 212 comprising at least one inner fluid conduit and at least one outer fluid conduit, spinning elements 224 configured for two-axis rotation, a support member 228 which supports the frame 212 and the spinning elements 224, and a ground support 232 (embodied, for example, as a spike) arranged at a distal end of the support member 228 for insertion into a support surface upon which the lawn ornament 210 is supported. Although embodiments illustrate ground spike 232 to be inserted into the support surface, embodiments are not limited to such a configuration. For example, the ground spike 232 may be embodied as a structure permitting secure placement of the lawn ornament 210 in an upright position on a support surface. In accordance with embodiments, at least one of the spinning elements 224 may have an ornamental or decorative appearance.

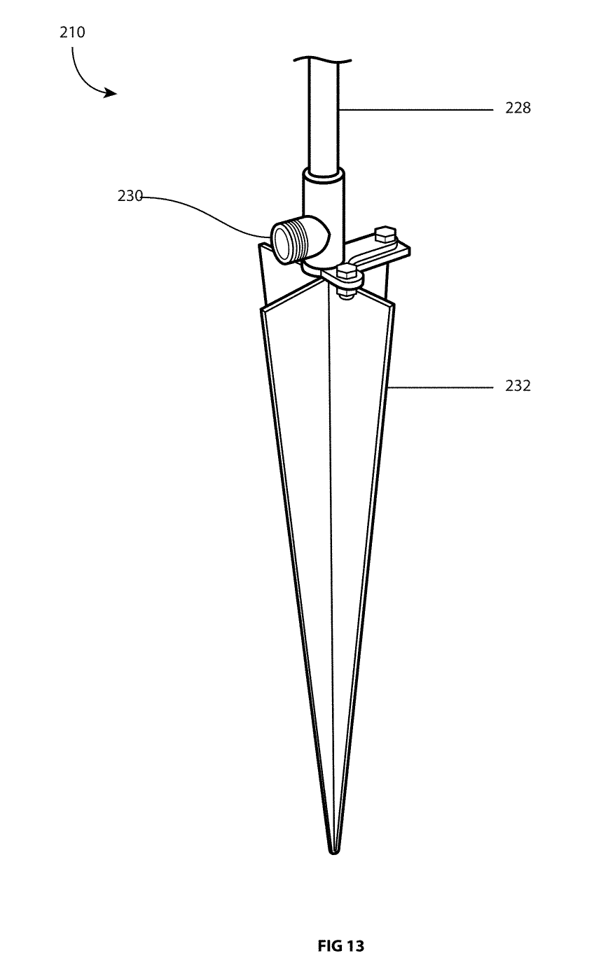

As illustrated in FIG. 13, the support member 228 includes a fluid connector 230 to permit fluidic communication of the lawn ornament 210 to a fluid source, such as, for example, a water supply system.

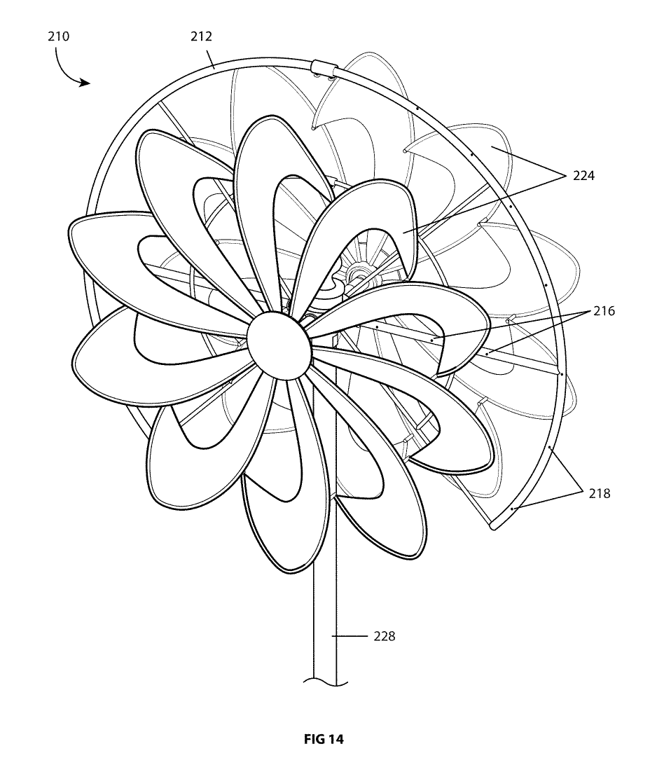

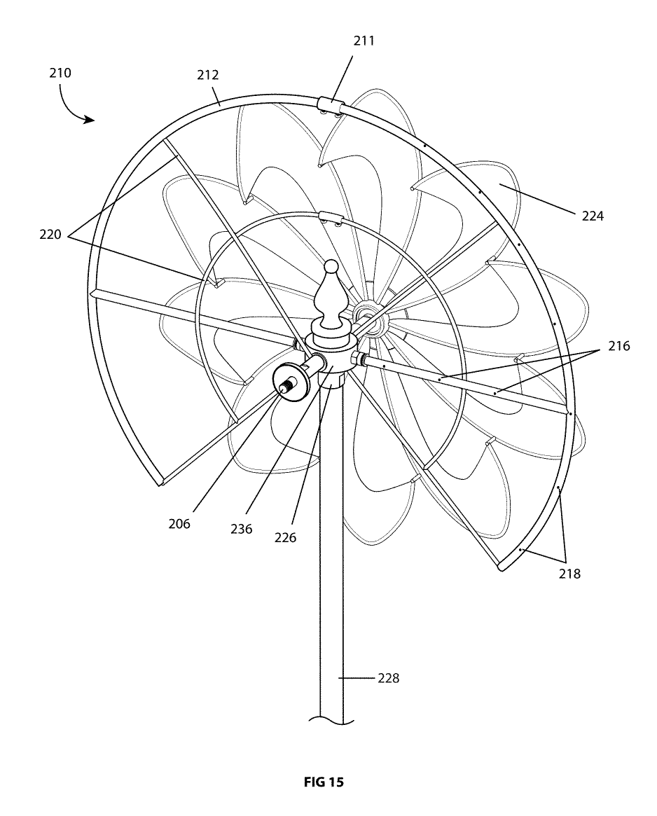

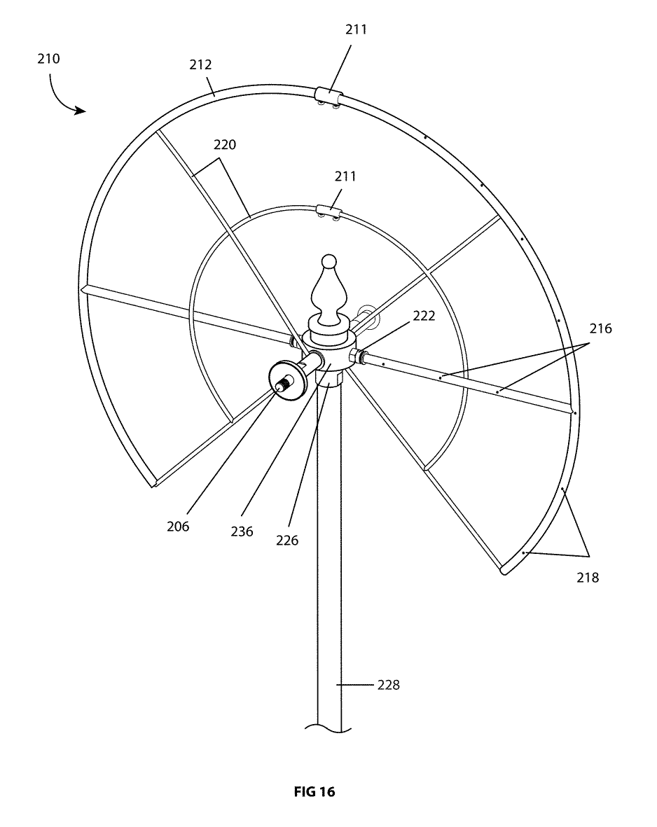

As illustrated in FIGS. 14 through 16, the frame 212 is to be supported on the support member 228 via central rotating member 236 and a connection collar 226. The support member 228 may be formed as a hollow pipe or one or more series of interconnected hollow pipes configured to permit the flow of a fluid (e.g., water) from the fluid connector 230 to the central rotating member 236 via the connection collar 226. The connection collar 226 is configured to mate with the central rotating member 236 using a series of bearing(s) and watertight seal(s) that permit the upward flow of fluid to be redirected laterally from the support member 228 out of the central rotating member 236 through the frame fluid connections 222 and into the frame 212.

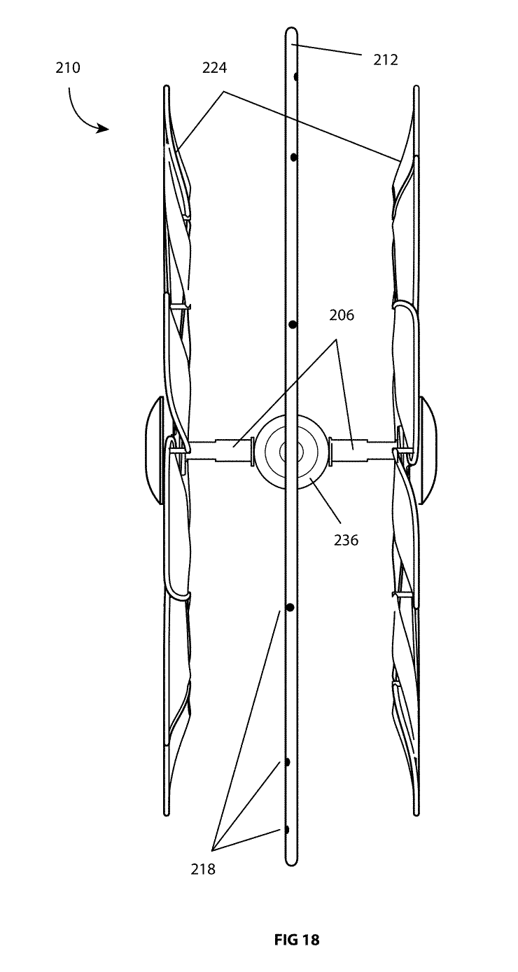

The frame 212 comprises at least one hollow tube. The at least one hollow tube of the frame 212 is braced with at least one frame support rod 220 that secures the frame 212 to the central rotating member 236. The hollow tubes of the inner portion of the frame 212 extend outwardly from the frame fluid connections 222 of the central rotating member 236 to fluidically connect to the outer portion of the frame 212. The outer portion of the frame 212 is configured to have an overall diameter that is greater than the diameter of the spinning elements 224 (FIG. 18). Embodiments, however, are not limited to such a configuration, and thus, the outer portion of the frame 212 may have any overall diameter that permits the practice of the embodiments.

All ends of the hollow tubes of the frame 212, except for the end that is connected to the central rotating member 236 are sealed to prevent the escape of fluid. Portions of the frame 212 may connected via a frame coupler 211.

The hollow tubing of the inner portion of the frame 212 is to include at least one outer or first aperture, nozzle, hole, or orifice 218. The hollow tubing of the outer portion of the frame 212 is to include at least one inner or second aperture, nozzle, hole, or orifice 216. In accordance with embodiments, the first orifices 218 are to be spaced apart from each other, while the second orifices 216 are to be spaced apart from each other.

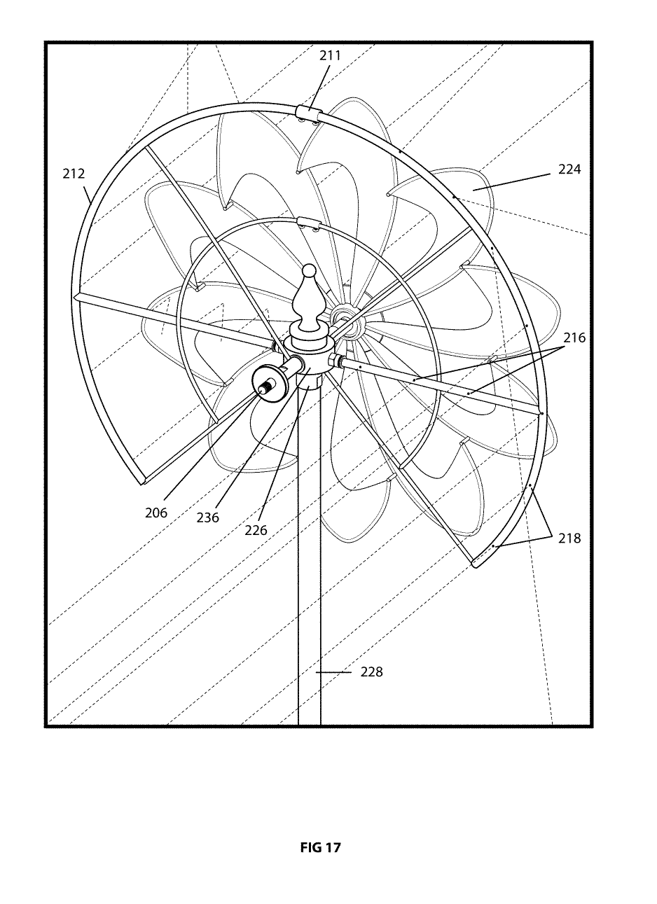

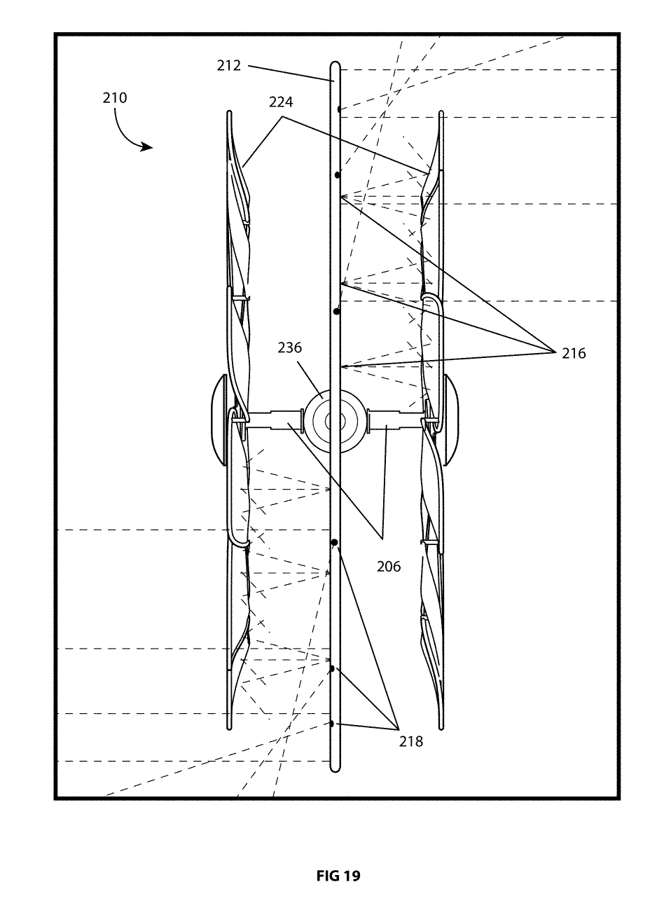

As illustrated in FIGS. 17 and 19, the second orifices 216 are configured to discharge or otherwise direct a portion of the fluid in a second direction to permit direct contact of the fluid with an inner surface of a corresponding one of the spinning elements 224. The spray pattern from the second orifices 216 is broken up upon impact with the vanes/blades of the spinning elements 224 such that the fluid is redirected and distributed to create a watering pattern close to the base of the lawn ornament 210. Such contact will promote the rotation of the spinning elements 224 about a horizontal axis defined by a corresponding axle 206, and also the rotation of the assembly (e.g., frame 212 and spinning elements 224) via the fluid connections 222 about a vertical axis defined by the support element 228 and thereby impart, induce, or otherwise cause rotation of the spinning elements 224 relative to the frame 212 and the support member 228. In that way, the spinning elements 224 may be driven not only by force of wind, but also by force of the contacting fluid discharged from the second orifices 216. In accordance with embodiments, each spinner element 224 may rotate about the horizontal axis independently of each other.

Due to the diameter of the frame 212 being greater than the diameter of the spinning elements 224, the first orifices 218 are configured to discharge a portion of the fluid therefrom which bypasses the spinning elements 224 and spray outward to both promote both a watering pattern on the support surface below while also producing the necessary torque to rotate the assembly on the vertical axis. The first orifices 218 may be orientated so that fluid leaves at various angles as necessary to distribute the fluid onto the support surface below. Meaning, some fluid may be discharged in an upward arching pattern to land fluid closer to the assembly, while some fluid may be discharged on a more horizontal pattern to maximize the distance of fluid from the lawn ornament 210.

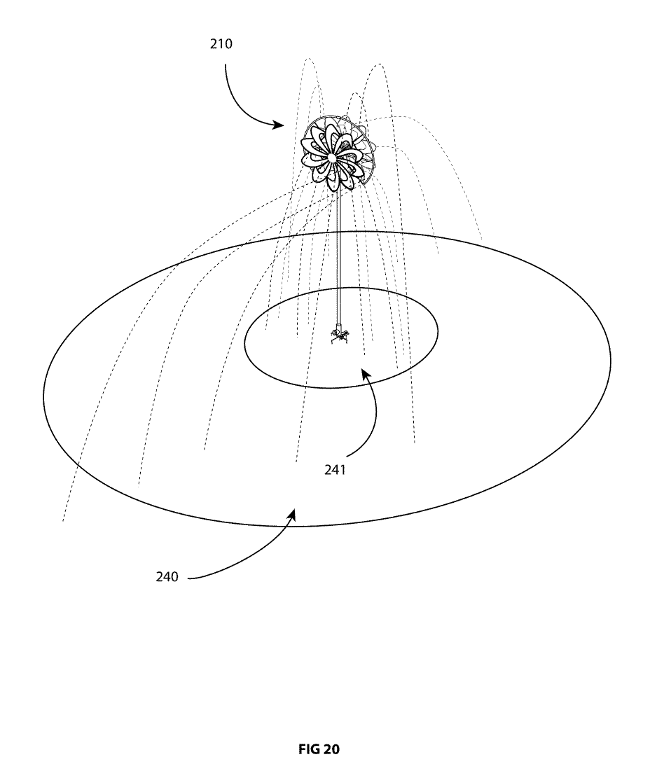

In accordance with embodiments, lawn ornament 210 is designed as to discharge fluid therefrom to soak, spray, or otherwise irrigate the surrounding ground area to create two distinct spray zones to promote even irrigation of the surrounding ground area. For example, the first orifices 218 are configured to direct a portion of the fluid to an area on the support surface that creates an outer fluid spray zone 240 while the second orifice(s) 216 is configured to direct another portion of fluid to an area on the support surface that creates an inner fluid spray zone 241 (FIGS. 19 and 20). The inner fluid spray zone 241 may be, for example, arranged concentric to the outer fluid spray zone 240. Alternatively, the fluid spray zones 240, 241 may be non-concentrically arranged with respect to each other. The inner fluid spray zone 241 is formed by direct impact of fluid discharged from the second orifice(s) 216, with the spinning elements 224.

Each orifice 216, 218 in accordance with embodiments may be arranged so as to maximize the spinning effect of the assembly. Meaning, orifices 216, 218 facing outwardly to the front of the assembly will be only on the right half of the assembly, while orifices 216, 218 facing outwardly to the rear of the assembly will only be faced on the left side of the assembly or vice versa (FIGS. 17 and 19). This arrangement creates torque so that the assembly will rotate on a horizontal axis defined by the central hub 226.

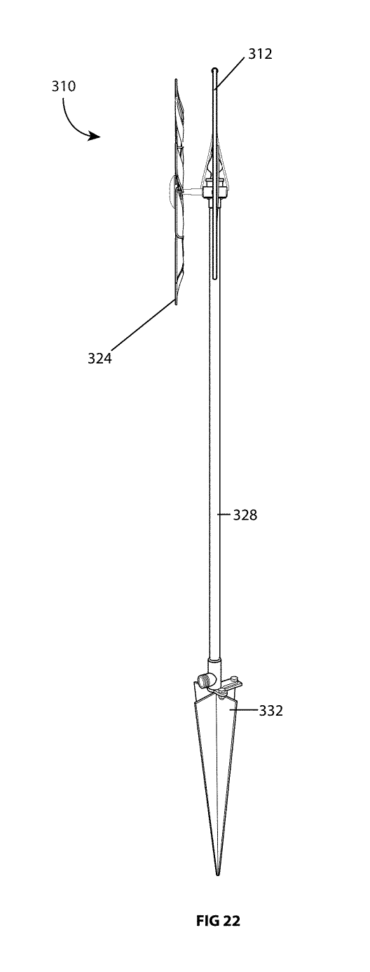

As illustrated in FIG. 22, in accordance with an embodiment, a decorative lawn ornament 310 may alternatively include a single spinning element 324. In such an embodiment, the spinning element 324 may be configured to rotate about both a horizontal axis and a vertical axis upon engagement of the fluid function. Alternatively, the spinning element 324 may be configured to rotate about a single axis upon engagement of the fluid function.

Embodiments relate to a decorative lawn ornament that utilizes either wind power or a flow of fluid to spin various elements of the decorative lawn ornament. When wind power is used, the spinning elements (which may resemble the vanes/blades on a fan) may spin in unison about a vertical axis. When a fluid power is used, the spinning elements will additionally rotate independently of each other on a horizontal axis, and will turn in unison about the vertical axis via the spinning central hub. When fluid power is used, the fluid may additionally be used for watering of a garden as the design of the decorative lawn ornament promotes an even distribution of fluid to the surrounding ground/support surface.

### ADDITIONAL NOTES AND EXAMPLES

Example One may include a lawn ornament comprising: at least one structural element; and a frame configured to receive a fluid from a fluid source, the frame including at least one fluid conduit having at least one first orifice and at least one second orifice, wherein the at least one second orifice is configured to discharge a portion of the fluid so as to cause rotation of the at least one structural element about a first axis, and the at least one first orifice is configured to discharge another portion of the fluid so as to cause rotation about a second axis which is different than the first axis.

Example Two may include the lawn ornament of Example One, wherein the frame has a diameter that is greater than a diameter of the at least one structural element.

Example Three may include the lawn ornament of Example One, further comprising a support member configured to receive the fluid from the fluid source.

Example Four may include the lawn ornament of Example Three, further comprising a central rotating member to connect the frame to the support member.

Example Five may include the lawn ornament of Example Four, further comprising an axle to rotatably connect the at least one structural element to the central rotating member.

Example Six may include the lawn ornament of Example Five, wherein: the axle defines the first axis; and the support element defines the second axis.

Example Seven may include the lawn ornament of Example Six, wherein: the first axis comprises a horizontal axis; and the second axis comprises a vertical axis.

Example Eight may include the lawn ornament of Example One, wherein the at least one first orifice of the outer fluid conduit is orientated so that the fluid leaves at various angles to distribute the fluid onto a support surface.

Example Nine may include the lawn ornament of Example One, wherein: a first group of the second orifices are arranged on a first side of the frame so as to discharge the fluid in a first direction; and a second group of the second orifices are arranged on a second side of the frame opposite the first side, so as to discharge the fluid in a second direction opposite to the first direction so as to generate torque to rotate the at least structural element and the frame in unison about the second axis.

Example Ten may include a lawn ornament comprising: a first structural element; a second structural element arranged spaced apart from the first structural element; and a frame to receive fluid from a fluid source, the frame having at least one first orifice and at least one second orifice, wherein the at least one second orifice is configured to discharge a portion of the fluid so as to cause rotation of the at least one structural element about a first axis, and the at least one first orifice is configured to discharge another portion of the fluid so as to cause rotation about a second axis which is different than the first axis.

Example Eleven may include the lawn ornament of Example Ten, wherein the frame has a diameter that is greater than a diameter of the first structural element and a diameter of the second structural element.

Example Twelve may include the lawn ornament of Example Ten, further comprising a support member configured to receive the fluid from a fluid source.

Example Thirteen may include the lawn ornament of Example Twelve, further comprising a central rotating member to connect the frame to the support member.

Example Fourteen may include the lawn ornament of Example Thirteen, further comprising an axle to rotatably connect the first structural element and the second structural element to the central rotating member.

Example Fifteen may include the lawn ornament of Example Fourteen, wherein: the axle defines the first axis; and the support member defines the second axis.

Example Sixteen may include the lawn ornament of Example Fifteen, wherein: the first axis comprises a horizontal axis; and the second axis comprises a vertical axis.

Example Seventeen may include the lawn ornament of Example Ten, wherein the at least one first orifice of the outer fluid conduit is orientated so that the fluid leaves at various angles to distribute the fluid onto a support surface.

Example Eighteen may include the lawn ornament of Example Ten, wherein: a first group of first orifices are arranged on a first side of the frame so as to discharge the fluid in a first direction; and a second group of the second orifices are arranged on a second side of the frame opposite the first side, so as to discharge the fluid in a second direction opposite to the first direction so as to generate torque to rotate the at least structural element and the frame in unison about the second axis.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A lawn ornament, comprising:
at least one structural element; and
a frame configured to receive a fluid from a fluid source, the frame including at least one fluid conduit having at least one first orifice and at least one second orifice,
wherein the at least one second orifice is configured to discharge a portion of the fluid so as to cause rotation of the at least one structural element about a first axis, and the at least one first orifice is configured to discharge another portion of the fluid so as to cause rotation about a second axis which is different than the first axis.

2. The lawn ornament of claim 1, wherein the frame has a diameter that is greater than a diameter of the at least one structural element.

3. The lawn ornament of claim 1, further comprising a support member configured to receive the fluid from the fluid source.

4. The lawn ornament of claim 3, further comprising a central rotating member to connect the frame to the support member.

5. The lawn ornament of claim 4, further comprising an axle to rotatably connect the at least one structural element to the central rotating member.

6. The lawn ornament of claim 5, wherein:
the axle defines the first axis; and
the support element defines the second axis.

7. The lawn ornament of claim 6, wherein:
the first axis comprises a horizontal axis; and
the second axis comprises a vertical axis.

8. The lawn ornament of claim 1, wherein the at least one first orifice of the outer fluid conduit is orientated so that the fluid leaves at various angles to distribute the fluid onto a support surface.

9. The lawn ornament of claim 1, wherein:
a first group of the second orifices are arranged on a first side of the frame so as to discharge the fluid in a first direction; and
a second group of the second orifices are arranged on a second side of the frame opposite the first side, so as to discharge the fluid in a second direction opposite to the first direction so as to generate torque to rotate the at least structural element and the frame in unison about the second axis.

10. A lawn ornament, comprising:
a first structural element;
a second structural element arranged spaced apart from the first structural element; and
a frame to receive fluid from a fluid source, the frame having at least one first orifice and at least one second orifice,
wherein the at least one second orifice is configured to discharge a portion of the fluid so as to cause rotation of the at least one structural element about a first axis, and the at least one first orifice is configured to discharge another portion of the fluid so as to cause rotation about a second axis which is different than the first axis.

11. The lawn ornament of claim 10, wherein the frame has a diameter that is greater than a diameter of the first structural element and a diameter of the second structural element.

12. The lawn ornament of claim 10, further comprising a support member configured to receive the fluid from a fluid source.

13. The lawn ornament of claim 12, further comprising a central rotating member to connect the frame to the support member.

14. The lawn ornament of claim 13, further comprising an axle to rotatably connect the first structural element and the second structural element to the central rotating member.

15. The lawn ornament of claim 14, wherein:
the axle defines the first axis; and
the support member defines the second axis.

16. The lawn ornament of claim 15, wherein:
the first axis comprises a horizontal axis; and
the second axis comprises a vertical axis.

17. The lawn ornament of claim 10, wherein the at least one first orifice of the outer fluid conduit is orientated so that the fluid leaves at various angles to distribute the fluid onto a support surface.

18. The lawn ornament of claim 10, wherein:
a first group of first orifices are arranged on a first side of the frame so as to discharge the fluid in a first direction; and
a second group of the second orifices are arranged on a second side of the frame opposite the first side, so as to discharge the fluid in a second direction opposite to the first direction so as to generate torque to rotate the at least structural element and the frame in unison about the second axis.
